(19) United States
(12) Patent Application Publication
(10) Pub. No.: US 2014/0295040 A1
(43) Pub. Date: Oct. 2, 2014

(54) COCOA-BASED EXERCISE RECOVERY BEVERAGES

(71) Applicants: Joseph MILICI, Mount Joy, PA (US); Amy Griel PRESTON, Harrisburg, PA (US); Heather M. ARENTZ, Hummelstown, PA (US)

(72) Inventors: Joseph MILICI, Mount Joy, PA (US); Amy Griel PRESTON, Harrisburg, PA (US); Heather M. ARENTZ, Hummelstown, PA (US)

(73) Assignee: THE HERSHEY COMPANY, Hershey, PA (US)

(21) Appl. No.: 14/171,353

(22) Filed: Feb. 3, 2014

Related U.S. Application Data
(63) Continuation of application No. 13/030,897, filed on Feb. 18, 2011, now abandoned.
Application No. 13/030,897 is a continuation-in-part of application No. 11/925,162, filed on Oct. 26, 2007.
(60) Provisional application No. 61/305,789, filed on Feb. 18, 2010.
(60) Provisional application No. 61/330,178, filed on Apr. 30, 2010.

(51) Int. Cl. A23C 9/156

(52) U.S. Cl. CPC A23C 9/156
USPC 426/330.2; 426/584

(57) ABSTRACT

The invention provides, in one aspect, a method of producing a ready-to-drink cocoa beverage containing high levels of beneficial cocoa flavanols or cocoa polyphenols and with a particular ratio of carbohydrates to protein. The beverages can advantageously be used in an exercise recovery regimen. Cocoa solids levels in the beverages can be selected from about 3.5% to about 10% by weight cocoa powder or the equivalent in cocoa product.

### RELATED APPLICATION

This application claims priority benefit to U.S. Provisional Applications 61/305,789 filed Feb. 18, 2010, and 61/330,178 filed Apr. 30, 2010, and is a Continuation-In-Part of U.S. application Ser. No. 11/925,162, filed Oct. 26, 2007, for which these applications are specifically incorporated herein by reference in their entirety.

### FIELD OF THE INVENTION AND INTRODUCTION

The invention relates to compositions and beverages made with high levels of cocoa solids, and consequently cocoa flavanol antioxidants, and which comprise an optimized carbohydrate to protein ratio. The beverages, while preferably using a dairy source or ingredient for protein, are not limited to the standard of identity for a chocolate milk product. Producing a beverage with high levels of cocoa powder, for example, will generally result in solution stability problems and can generate a rather astringent taste. The methods of the invention allow the production of dairy and even soy based liquids to be combined with amounts of cocoa products not previously used or deemed palatable. The results are healthy products with intense chocolate flavor that are especially useful as exercise recovery beverages.

### RELEVANCE OF THE INVENTION AND DESCRIPTION OF RELATED ART

Evidence suggesting that chocolate milk, as defined by the US standard of identity, can be used in recovering from strenuous physical activity was published a few years ago. However, research since those initial reports has focused on the carbohydrate and protein levels present in recovery beverages. Furthermore, measurements of biochemical markers associated with exercise recovery (i.e. Creatine Phosphokinase (CPK), Lactate Dehydrogenase (LDH), and Nitric Oxide metabolites (NOx)) has not correlated performance to clinical measurements and the ability to alter the levels of these markers after administration of recovery beverages. Accordingly, there continues to be a need in the art for detailed measurements of the usefulness and mechanism of action for exercise recovery beverages, especially those containing cocoa, and the administration regimens employed with these beverages.

More and more evidence shows the health benefits of cocoa antioxidants or cocoa flavanol compounds in the diet. However, adding cocoa products to a beverage in higher levels in order to deliver the levels suggested for these health benefits causes taste problems in the bitterness inherently present in cocoa solids. Typically, about 1.5% or less by weight cocoa powder or the equivalent in cocoa solids is used in a chocolate milk product. In addition, manufacturers of ready-to-drink beverages appreciate the difficulties of producing an acceptable mouthfeel while at the same time preserving the suspension of ingredients in milk or other base liquids. This is especially difficult in refrigerated or iced products. Numerous mixtures of stabilizers, including micro-crystalline cellulose and various gum ingredients, have been used in the past. Similarly, sterilization of milk-based beverages for the commercial storage conditions used can result in off-flavors from the enzymatic or other degradation of milk and other components. Accordingly, the stability of the initial mouthfeel, flavor, and suspension properties of cocoa-based products with high levels of cocoa (more than 3% cocoa powder or equivalent in cocoa solids) is difficult to achieve in a commercial manufacturing setting. Additional mouthfeel and suspension problems arise from the use of cocoa and the carageenans commonly present with cocoa in chocolate flavors.

The invention, in one aspect, provides ready-to-drink cocoa-based beverages that can be used in exercise recovery methods in order to beneficially affect the levels of creatine kinase and nitric oxide in active individuals. Additionally, the manufacture or production of these beverages with the novel processes described herein allows the production of a shelf-stable, highly intense cocoa flavored beverage with high levels of cocoa flavanols or antioxidants. The ready-to-drink beverages possible from the invention can be stored for six months, or twelve months or longer at room temperature without degradation in taste, mouthfeel, or suspension, and thus can be produced as extended shelf life products.

### BRIEF SUMMARY OF THE INVENTION

The present invention relates to beverages with high levels of cocoa flavanols from cocoa solids, or more specifically a cocoa powder, and the use of these beverages in exercise recovery regimens. Exercise routines and cocoa beverage administration regimens are designed to measure biochemical markers in each of two intense workouts separated by a rest period, approximately four hour rest between exercises. The exercise routines are designed to test subjects to exhaustion and blood samples are taken before and after. Levels of Creatine Phosphokinase (CPK), Lactate Dehydrogenase (LDH), plasma nitrates and Nitric Oxide metabolites (NOx) can then be correlated with physical performance and the type of recovery beverage used, and the amount of cocoa powder, or cocoa solids or cocoa flavanols, present in the beverage. As shown below, beverages with higher levels of cocoa solids or cocoa flavanols enhance muscle recovery after intense exercise.

The beverages themselves can be made using an ultra-high temperature heating process. In one embodiment, the ultra high temperature heating is about 290° F. or about 140° C. and can be used to swell the components in a milk or dairy-based product with cocoa powder or cocoa solids. Alternatively or in addition to dairy-based products or milk protein containing products, soy-based products can be used. After this heating, the mixture is cooled and homogenized. In a preferred embodiment, dairy proteins and components are used and the homogenization occurs at about 170°-180° F., and a further preferred aspect employs aseptic homogenization, and in an especially preferred embodiment homogenization occurs after heating to aseptic conditions.

High levels of cocoa are a source of starch and when heated at 170°-180° F. can solidify and become viscous at those temperatures. In the inventive process, aseptic homogenization, or ultra-high temperature conditions followed by homogenization, results in advantageous characteristics in beverages such as a reduction in viscosity and improved mouthfeel. Accordingly, the beverages of the invention, in particular, can be produced from the inventive methods to reduce the overall viscosity of the final product.

One advantageous aspect of the method to produce the beverages is the ability to combine all ingredients once and then process to final filling. In contrast, many existing manufacturing processes require the addition of a separate stabilizer, or components with stabilizers and emulsifiers, and/or combine flavors, in a separate processing step, which potentially compromises the in-line production and sterile conditions.

In another aspect, the invention relates to beverages having a milk and/or soymilk base that contain high levels of cocoa powder, or the equivalent in cocoa solids, in the range of greater than 3.5% total cocoa powder by weight, or up to about 9% total cocoa powder by weight, or about 10% by weight total cocoa powder.

In particular, beverages with cocoa powder levels (or the equivalent in cocoa solids) of about 3.5% or about 6% can be used, especially in combination with a carbohydrate to protein ratio of about 3:1, or from about 2.5:1 to about 4:1 or any ratio in between. Contrary to other products with high levels of cocoa solids, the beverages of the invention can be made so that they do not display a bitter or astringent taste characteristic. Furthermore, the beverages have an acceptable mouthfeel, maintain a stable solution with substantially no bottom residue or separation after storage for up to 6 or 12 or more months, and are stable to room temperature and cooled storage conditions.

In one preferred embodiment, the invention comprises a method to produce a shelf-stable or extended shelf life chocolate beverage or shake-type product with high levels of cocoa as well as the products themselves. In general, a shelf stable product is one that can be safely stored and sold in a sealed container at room temperature while still retaining its basic characteristics, such as remaining in suspension. The technology for extending the shelf life of products involves increasing the microbial reduction level during processing, avoiding re-contamination during filling, and maintaining a reduced microbial level during distribution temperatures. One of skill in the art is familiar with techniques to produce shelf stable and extended shelf life products according to the invention and any available technology can be used for these purposes. A whole milk, reduced fat milk, substantially fat-free milk, a soymilk, or water or other aqueous liquid or composition can be used as a base. In addition, whey protein, casein, or milk protein isolates and/or one or more amino acids can be added.

The products can be made with about 3% natural cocoa powder by weight, and levels up to about 9% or about 10% can be produced, as well as any desired range between 3% and 10%. Most preferred is about 3.5% to about 6.5% total cocoa powder by weight, where the natural cocoa powder is from about 3% to about 6% of the total cocoa powder present. Thus, combinations of cocoa powder can be used in embodiments of the invention, such as where about 3% natural cocoa powder plus about 0.5% alkalized cocoa powder is used, and a variety of other combinations of natural cocoa powder, alkalized cocoa powder, cocoa powder from unroasted cocoa beans, cocoa powder from unfermented cocoa beans, and cocoa powder from unfermented/unroasted cocoa beans are possible to reach a combined level from about 3.5% to about 10% total by weight. As noted above, cocoa products containing the equivalent amount of cocoa solids can be used instead of cocoa powder or in addition to using all cocoa powder in order to provide the same cocoa content or same amount of cocoa flavanols.

The levels of natural cocoa powder or natural cocoa products present as compared to the levels of other cocoa products can be presented by a percentage of natural cocoa products to total cocoa products, so that, for example, between 80-90% of the total cocoa products present are natural cocoa products. Preferably, the combination of cocoa powders or products yields a stable, shelf stable, and/or extended shelf life product with antioxidant levels of about 10,000 umol TE per 8 oz serving (Trolox Equivalent in an Oxygen Radical Absorbance Capacity ORAC assay), or about 575 mg total polyphenols per 8 oz serving, or about 345 mg polyphenol monomers per 8 oz serving, or about 547 mg GAE per 8 oz serving (gallic acid equivalent). In particular, an 8 oz. serving can have more than 200 mg of total polyphenols (TP), or more than 500 mg TP, or more than 1,000 mg TP, or more than 1,500 mg TP. In other preferred embodiments of an 11 oz. serving size, the levels of particular cocoa flavanol compounds and total cocoa flavanols are:

| | Catechins | Epicatechins | Procyanidins | Total Cocoa |
|---|---|---|---|---|
| Formula | (mg) | (mg) | (mg) | Flavanols (mg) |
| 3.5% Natural | 14.7 | 21.7 | 122.5 | 158.9 |
| Cocoa | | | | |
| 6.0% Natural | 28 | 49 | 262.5 | 339.5 |
| Cocoa | | | | |
| 5.0% Nat + | 24.8 | 38.5 | 206.5 | 269.8 |
| 1.0% Alk | | | | |
| Comparative I | 0.34 | <0.001 | <0.001 | <1 |
| Recovery Milk | | | | |
| Choc Flavored | | | | |
| Beverage | | | | |
| Comparative II | <0.001 | <0.001 | <0.001 | <1 |
| Recovery Choc | | | | |
| Flavored | | | | |
| Beverage | | | | |
| Comparative | 0.51 | 1.02 | 2.54 | 4.07 |
| Choc Milk | | | | |

In the various comparative exercise recovery and chocolate milk beverages containing cocoa listed in the above table, the cocoa used must be alkalized cocoa or the levels of cocoa very low in order to have the low levels of beneficial cocoa flavanol antioxidants. The 3.5% and 6% compositions from above are water-based aqueous compositions of the invention, with high levels of natural cocoa powder (3.5% and 6% by weight). The 5% natural cocoa+1% alkalized cocoa sample of the invention is a dairy-based aqueous composition. In the table above, the total cocoa flavanols represents the catechins+epicatechins+procyanidin polymers (up to 10-mers) measured from each formula. One of skill in the art is familiar with numerous and similar measurements for antioxidant capacity and flavanol and antioxidant quantification, and any method available can be used. In addition, the combination of natural cocoa powder and alkalized cocoa powder, and other cocoa powders, cocoa products or extracts, can provide a broad taste and bitterness profile and can be used to improve taste, bitterness, and color in a final product.

In other embodiments, the invention includes an exercise recovery composition comprising from about 12 to about 22 grams of natural cocoa powder per serving, such as an 11 oz. serving, or the equivalent in a cocoa solids-containing product, and about 2.5 to about 4 times by weight of total carbohydrate to protein present. Preferably, the total carbohydrate present is predominately from a simple carbohydrate. As used herein, a simple carbohydrate is a relatively low-length chain such as a mono- or disacharride. The simple carbohydrate is not a complex carbohydrate such as maltodextrin. In other embodiments, the compositions or beverages contain about 3.5% to about 10% cocoa powder, or the equivalent in cocoa solids-containing product, as well as simple carbohydrate in the levels noted above. A preferred simple carbohydrate is sucrose, which is often referred to as “sugar” in the art. A simple carbohydrate can be any known in the art, including, alone or in any combination, sucrose, fructose, maltose, dextrose, liquid fructose, lactose, glucose, trehalose, agave syrup, corn syrup, invert sugar, honey, cane syrup, maple sugar, brown sugar, and molasses, for example. These compositions of the invention are suitable for exercise recovery and can be administered immediately following exercise or up to 60 minutes following strenuous exercise. In general, these compositions can be used to treat athletes before, during, or after exercise or exercise recovery. These compositions can preferably be formulated into a beverage. In a preferred embodiment, the composition is substantially free of lactose, meaning no ingredient containing lactose as a component is used, but lactose may be present in trace amounts. These compositions and beverages can also be combined with various vitamins, minerals, salts, and cocoa extracts, and combinations of these. In particular, a cocoa product from unfermented, under-fermented, or raw cocoa beans can be added. Furthermore, the compositions or beverages of the invention can contain a stabilizing agent, such as microcrystalline cellulose.

Administering these compositions, or the beverages disclosed here, can be used in methods to enhance the energy supply after exercise, for example in an athlete. Similarly, administering the compositions or beverages of the invention can be used in methods to increase the bioavailability of blood glucose in muscle tissue following exercise. As shown in FIG. 2, the available glucose after treatment or administration of the compositions or beverages of the invention increases dramatically compared to control compositions. In FIGS. 3-4, the beneficial levels of both nitric oxide and endothelin-1 also indicate the dramatic value of the compositions and beverages in muscle recovery following a stress, such as strenuous exercise.

As noted, the methods and products use some or mostly natural cocoa or extracts that are not treated with alkaline, or alkalized cocoa. Natural cocoa and cocoa products that have not been treated with alkaline conditions have higher levels of cocoa flavanols, flavanol antioxidants, and cocoa polyphenols. A variety of cocoa powders, cocoa extracts, cocoa concentrates, cocoa compositions, cocoa solids, and cacao bean compositions are known and available to one of skill in the art and can be selected for use in any aspect of the invention. In addition, extracts with enhanced levels of cocoa flavanols or cocoa polyphenols, or extracts with additives, can also be selected for use and can be combined with the cocoa products mentioned above. Furthermore, combinations of cocoa powders, extracts, enhanced extracts, concentrates, extracts with additives can be selected and used for any aspect of the invention. The terms “cocoa solid” and “cocoa bean” compositions can be any of a variety of products and combinations as well as specific combinations of the cacao bean-derived products noted in this disclosure and/or available to one of skill in the art. Where “cocoa powder” is used, an equivalent amount or level of a cocoa solids-containing product can also be used, such as chocolate liquor, cocoa kibble, baking chocolate, non-fat cocoa powder, and other cocoa products available.

In particularly preferred embodiments, the invention comprises beverages that contain efficacious cocoa polyphenols and/or cocoa antioxidants. Along with the exercise recovery uses and methods described here, these beverages can be used in a healthy diet, for example a diet to improve cardiovascular conditions or prevent cardiovascular disease, high blood pressure, atherosclerosis, arteriosclerosis, or other diseases. Another aspect of the invention is to provide a cocoa beverage composition that is a lactose-free, no sugar added, sugar-free, low calorie, and/or substantially calorie-free cocoa beverage. Yet another aspect of the invention is to provide a cocoa beverage that is no sugar added, sugar-free, low calorie, and/or calorie-free or substantially calorie-free product and which optionally contains other available or known supplements, active ingredients, appetite suppressing agents, and similar agents or ingredients, especially those also found in antioxidant-containing plant products and foods, such as, but not limited to, herbs, teas, coffees, and berries. Further, the beverage compositions may be combined with one or more other dietary nutrients, such as vitamins, minerals, amino acids, sterols, plants sterols, omega-3 fatty acids, etc., to provide a nutritional or dietary supplement. Any of these combinations of the invention can advantageously provide benefits to human health and capture additional beneficial effects. All of the ingredients or combinations may be combined with appropriate stabilizers, preservatives, binders, emulsifiers, weighting agents, and other edible or ingestible compounds known to one of skill in the art in the industry to produce a beverage.

Throughout this disclosure, applicants refer to journal articles, patent documents, published references, web pages, and other sources of information. One skilled in the art can use the entire contents of any of the cited sources of information to make and use aspects of this invention. Each and every cited source of information is specifically incorporated herein by reference in its entirety. Portions of these sources may be included in this document as allowed or required. However, the meaning of any term or phrase specifically defined or explained in this disclosure shall not be modified by the content of any of the sources. The description and examples that follow are merely exemplary of the scope of this invention and content of this disclosure and do not limit the scope of the invention. In fact, one skilled in the art can devise and construct numerous modifications to the examples listed below without departing from the scope of this invention.

### BRIEF DESCRIPTION OF THE DRAWINGS

FIG. 1 is a flow chart of an exemplary process for making the beverages of the invention and the steps used in such a process.

FIG. 2 is a graph showing the change in available glucose in the blood of subjects treated with recovery beverages of the invention (3.5% cocoa [diamond, solid line] and 6% cocoa [square, thick dashed line]) and in comparison to conventional chocolate milk [triangle, small dashed line] and Comparative I Recovery Milk Chocolate Flavored Beverage [circle, dotted line]. As evident from this graph, both of the cocoa beverages of the invention provide substantially higher levels of available glucose.

FIG. 3 shows the change in serum nitrate (a marker of nitric oxide) levels 2 hours after consuming the beverages of the invention—3½% natural cocoa; blend of 5% natural cocoa+1% alkalized cocoa; 6% natural cocoa; and placebo with no cocoa solids.

FIG. 4 shows the changes in the plasma endothelin-1 levels 2 hours post treatment for the same samples as in FIG. 3. There is an inverse relationship between nitric oxide (NO) levels and ET-1 levels.

### DETAILED DESCRIPTION OF EXEMPLARY EMBODIMENTS

In general and as used in this invention, the various cocoa-containing extracts, products or compositions noted here refer to the terms as used in Minifie (Chocolate, Cocoa, and Confectionery, 3d ed., Aspen Publishers), specifically incorporated herein by reference. The cacao bean (or cocoa bean) refers to the cacao bean in nature. Cocoa containing products or bean compositions are products derived from or having some component, but not the separated cocoa butter component, derived from the cocoa bean, fermented cocoa bean, unfermented cocoa bean, blanched cocoa bean, unroasted cocoa bean, and/or fermented and roasted cocoa bean. Cocoa powder refers typically to cocoa solids with a total of 10% to 12% fat, where the fat is cocoa butter. Defatted cocoa powders are cocoa powders with reduced levels of fat or have substantially all fat removed, and particular embodiments of the invention can be made from some or all of defatted cocoa powder or products, and/or some or all of cocoa powders or products containing substantially no cocoa fat. Some of the cocoa powders available contain, for example, about 3% or less cocoa fat, and these can be used in the invention.

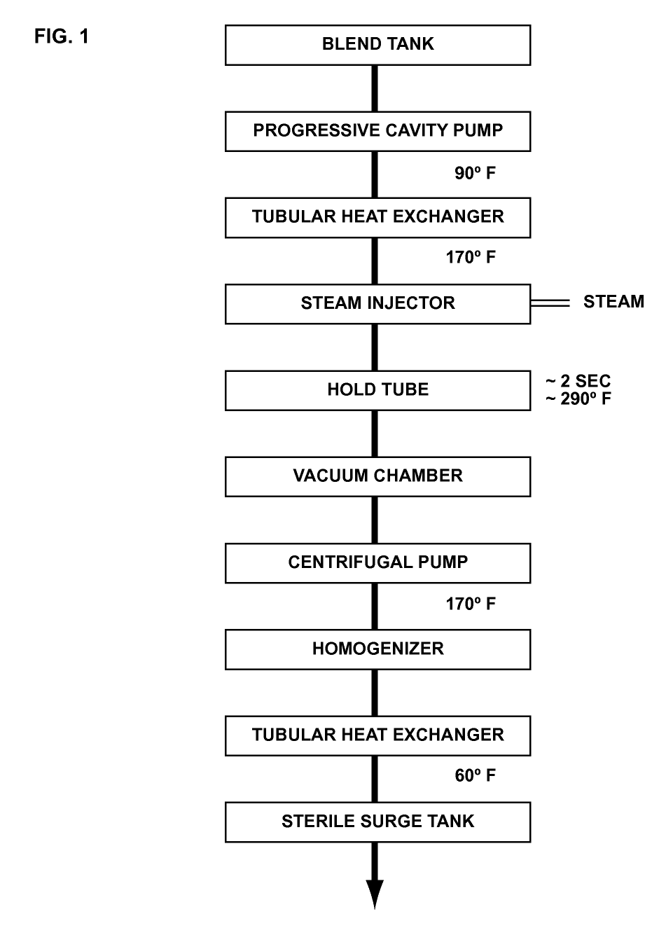

The compositions and beverages of the invention will be, in most cases, cocoa polyphenol containing and/or cocoa flavanol antioxidant containing beverages and compositions and are generally produced from natural cocoa or cocoa powder, which is the product resulting from pressing the lipid content from chocolate liquor, cacao bean nibs, or fermented and roasted cacao bean nibs. As noted, unroasted and/or unfermented cacao beans or cocoa products made from them can also be used to produce the compositions and beverages of the invention, and several unroasted and/or unfermented cacao products are available for use. In particular, unroasted and unfermented cacao beans, and optionally raw beans that have been briefly heat-treated or blanched, can be used to produce a cocoa powder or other cocoa products that contain high levels of cocoa polyphenols, and the powders, extracts, and concentrates from these unroasted and unfermented beans can be used in particular embodiments of the invention. Also, unroasted raw beans and cocoa products derived from unroasted raw beans can be used, or used in combinations of cocoa powders or products, by incorporating them into ingredients prior to aseptic heating or heating to about 275° to about 290° F. to sterilize the raw beans or products being made. Raw or untreated cocoa bean compositions have a higher likelihood of microbiological growth/contamination or may be more prone to such microbiological growth/contamination than other cocoa bean compositions. Usually or optionally, a pre-treatment step is used prior to incorporating a raw bean or raw bean product or extract into an aseptic process, for example pre-treating raw beans or material derived from raw beans at about 80° C. for up to 30 minutes. Employing the method steps of the invention (see, for example, FIG. 1), however, such a pre-treatment sterilization step is not required, as the high temperature treatment or sterilization can occur during the mixing of the beverage components. Accordingly, the invention offers improved and streamlined manufacturing and production options for many different cocoa-based beverages.

As used herein, the terms “cocoa powder,” “cocoa bean compositions,” and “cocoa products” can mean a product from a cacao bean, regardless of the method or treatment employed to produce the powder, composition or product. In addition, combinations of cocoa products or cocoa powders produced from different types of cacao beans or from different bean processing methods or conditions can be used. In particular, combinations of natural (non-alkalized) cocoa powder and dutched or alkalized cocoa powder can be used, and preferred mixtures of these powders have about 15% or about 10% or less dutched cocoa powder, as shown in the examples of Table 2. Other cocoa products, such as breakfast cocoa, cocoa syrups, and cocoa liquors can be used. Breakfast cocoa is cocoa solids with 20 to 24% fat, where the fat is cocoa butter.

As one of skill in the art understands, a certain amount or percentage of cocoa solids in a food ingredient can be achieved, inter alia, by using or adding an amount of cocoa powder, liquor, or other chocolate or cocoa ingredient containing the requisite amount of cocoa solids. Similarly, a certain amount or percentage of cocoa in a food ingredient can be achieved, inter alia, by using or adding an amount of cocoa powder, chocolate liquor or other chocolate or cocoa ingredient. In addition, while a cocoa containing product having a particular antioxidant or polyphenol level is not required, the invention encompasses the use of cocoa containing products with enhanced, altered, or increased levels of antioxidants or polyphenol compounds as compared to conventional cocoa containing products. A variety of production methods, extraction methods, and the addition of extracts or cocoa-derived polyphenols have been mentioned and can be used by one of ordinary skill in the art to create cocoa beverages and compositions of the invention. Other nutritional, therapeutic, or preventative ingredients can be added as well, as known in the art. Specifically, vitamins and minerals and mixtures of them can be added to the beverages or compositions, especially various forms of vitamins A, C, D, and E. The fiber content of the beverages, present from the cocoa solids or other optional ingredients, can provide a sustained release effect to the beneficial exercise recovery components found in the beverages of the invention (see table below, comparing same samples as discussed in table above comparing total cocoa flavanols).

| | | Fiber as % DV |
|---|---|---|
| | Serving Size | (25 grams = 100% |
| Formula | (oz) | DV) |
| 3.5% Natural Cocoa | 11 | 20 |
| 6.0% Natural Cocoa | 11 | 32 |
| 5.0% Nat + 1.0% Alk | 11 | 28 |
| Comparative I Recovery | 8 | 7 |
| Milk Choc Flavored | | |
| Beverage | | |
| Comparative II Recovery | 11 | 4 |
| Choc Drink Flavored | | |
| Beverage | | |
| Comparative Choc Milk | 11 | 2 |

Thus, dietary fiber from exclusively a cocoa source provides a functional component to the beverages of the invention, which does not require any additional fiber ingredient. This functional aspect of the use of high levels of cocoa product/fiber supplements the exercise recovery benefits from the cocoa flavanol antioxidants alone. Additional fiber ingredients can be used, however. The range of cocoa fiber can be anywhere from about 4 to about 20 grams per 11 oz. serving, and preferred embodiments of an 11 oz serving size can contain from about 5 to about 10 grams of cocoa fiber, present from the natural cocoa powder or other cocoa product or extract used in the beverage. Beverages with no added fiber but containing a high fiber content from cocoa alone are thus included in the invention.

With respect to cocoa polyphenols, numerous studies have indicated a strong inverse correlation between heart disease and the consumption of polyphenol-containing compounds (Vita, J. A., Am J Clin Nutr 81(Suppl):292S-7S (2005)). Although cocoa beans and the products thereof have been considered to have health promoting properties for thousands of years, dating back to ancient Central American cultures, recent analytical technologies have allowed for characterization of specific chemistry of the cocoa bean (Hurst, W. J. et al., Nature 418: 289-90 (2002)). Analysis of cocoa, the main product of the cacao bean, indicates that it is highly concentrated in certain polyphenol compounds, specifically in the flavanoid family. The most abundant flavanoids in cocoa are the flavanols, including the monomeric forms of epicatechin and catechin, as well as the oligomeric forms of them. The monomeric forms as well as the lower level polymers have been demonstrated to be bioavailable, reaching peak plasma concentrations two hours post-consumption (Baba, S., Free Radic Res 33(5):635-412 (2000)).

The process shown in FIG. 1 is merely one example of the methods of the invention adapted for sterile fill procedures. The ingredients are added to a blend tank, mixed, and pumped through the system using a pump, for example a progressive capacity pump. The mixture is first used at about 90° F., but other temperatures, such as between about 35° F. to about 170° F. can be used. This flowable mixture is then pumped through a heat exchanger to reach about 170° F. This mixture is then pumped through an ultra high temperature treatment tube, for example at temperatures about 290° F. and about 40-50 psi, typically using a steam heat process. Alternatively, these heating conditions can be between about 275° F. to about 290° F. to sterilize the product. Various hold times for the ultra high temperature treatment can be used, and a preferred time is about 1 second or about 2 seconds, or from about 1 second to about 10 seconds. The mixture can then be cooled and pumped into a homogenizer and then through a second heat exchanger to reduce the temperature. Numerous in-process homogenizing devices are available and can be selected for use. Optionally, final fill additives can be sterile filled on the way to a sterile filling area. Thus, the invention, in one aspect, incorporates the use of an aseptic homogenization step in processing a final product, where the homogenization occurs after an ultra high temperature heating treatment step. Aseptic homogenization, according to the methods of the invention, results in advantageous characteristics in beverages such as a reduction in viscosity and improved mouthfeel.

The beverages of the invention can include differing levels of cocoa solids, as represented by the % cocoa powder by weight. Two preferred examples are 3.5% cocoa powder and 6% cocoa powder formulations, as shown in the Table A below in both regular (approx 220 calories per 11 oz. serving) and “Light” (140 calories per 11 oz. serving) or low calorie options. These exemplary beverages can be prepared from a water-based or aqueous composition, where milk protein isolates are used for the protein source. Thus, they can be lactose-free beverages.

TABLE A

| | | | | Light- | |
|---|---|---|---|---|---|
| Ingredient | 3.5% | 6% | Light-3.5% A | 3.5% B | Light 6% |
| Water | 83.4615% | 81.0115% | 87.2038% | 87.1173% | 85.6765% |
| Sugar | 7.0000% | 7.0000% | 5.7000% | 5.0000% | 4.6000% |
| Sucralose | | | 0.00205% | 0.00316% | 0.00379% |
| Asulfame Potassium | | | 0.00068% | 0.00105% | 0.00126% |
| Milk Protein Isolate | 3.0600% | 3.0600% | 2.2750% | 3.0600% | 2.4000% |
| Maltodextrin | 0.5000% | 0.5000% | | | |
| Rice Starch | 0.5000% | 0.5000% | | | |
| Vitamin mix | 0.3700% | 0.3700% | 0.3700% | 0.3700% | 0.3700% |
| Cocoa Powder (Natural) | 3.5000% | 6.0000% | 3.5000% | 3.5000% | 6.0000% |
| Carboxymethylcellulose/ | 0.4000% | 0.3500% | 0.4500% | 0.4500% | 0.4500% |
| Cellulose gel | | | | | |
| Carrageenan | 0.0100% | 0.0100% | 0.0100% | 0.0100% | 0.0100% |
| Salt | 0.2275% | 0.2275% | 0.2275% | 0.2275% | 0.2275% |
| Vanillin | 0.0810% | 0.0810% | 0.0810% | 0.0810% | 0.0810% |
| Vanilla Flavor | 0.0700% | 0.0700% | 0.0700% | 0.0700% | 0.0700% |
| Antifoam | 0.0100% | 0.0100% | 0.0100% | 0.0100% | 0.0100% |
| Canola Oil | 0.8100% | 0.8100% | 0.1000% | 0.1000% | 0.1000% |
| Total | 100.0000% | 100.0000% | 100.0000% | 100.0000% | 100.0000% |

The beverages of the invention can be produced with high levels of cocoa, comparable to about 11 gm/serving of cocoa powder in a dry product, or in an 8 oz beverage serving size, and having a density about 1.09 gm/cc and a net weight of 267.9 gms.

Exercise Recovery Testing

In order to show the action of cocoa-based exercise recovery beverages, a variety of tests on human subjects can be performed. For example, subjects can be provided a first serving of the study beverage immediately after completing the first exercise session. Subjects can then be provided a second serving of the study beverage 2 hours after completing the first exercise session. For the Cocoa Product beverages and placebo, the serving size will be about 11 ounces. Subjects will be instructed to drink the entire beverage within 15 minutes. For the fluid replacement (FR) test beverage, the serving size will be 13.7 ounces (so that the sugar content and placebo will be the same). Again, subjects will be instructed to drink the entire beverage (13.7 ounces) within 15 minutes. Subjects may drink water with the study beverage and throughout the exercise test visit ad libitum. Water intake will be monitored.

The following “Exhaustive Exercise” treadmill protocol can be utilized to induce muscle soreness: Subjects will begin with a 5 minute warm-up at 0% grade and 50% of their maximum heart rate (max HR); after the warm-up, the subject will walk/run for 30 minutes at −10% grade (decline) at 75% of their max HR; following the 30 minute exercise session, subjects will continue with a 5 minute cool-down at 0% grade and a self-selected speed.

The following “Time to Exhaustion” (TTE) protocol can be used to determine treadmill time to exhaustion:

| Stage | Start Time | Speed | Grade |
|---|---|---|---|
| 1 | −5 minutes | Subject-selected speed | 0% |
| | | (comfortable pace) | |
| 2 | 0 minutes | 4.2 miles per hour | 0% |
| 3 | 3 minutes | 4.2 miles per hour | 2.5% |
| 4 | 6 minutes | 4.2 miles per hour | 5.0% |
| 5 | 9 minutes | 4.2 miles per hour | 7.5% |
| 6 | 12 minutes | 4.2 miles per hour | 10.0% |
| 7 | 15 minutes | 4.2 miles per hour | 12.5% |

The subject may not complete all stages of the TTE protocol. When the subject reaches volitional exhaustion and places his/her hands on the handrails, the treadmill grade is decreased to 0% and the speed to the original subject-selected speed. The subject will continue walking for 5 minutes for a cool-down. The test coordinator can start the timer when the treadmill reaches 4.2 miles per hour (stage 2) and the subject removes his/her hands from the handrails. The coordinator can stop the timer when the subject places his/her hands back on the handrails.

Subjects should be scheduled for 4 exercise test visits at approximately the same time of day (±120 minutes). To maintain a proper baseline, each subject should: refrain from any foods or beverages other than water for the 8 hours prior to the visit; refrain from any foods high in flavanoids, nitrates or arginine or eat/drink any chocolate milk, protein shakes or whey protein supplements in the 2 days prior to the visit; refrain from alcohol for the 2 days prior to the visit; refrain from any vitamins, minerals or dietary supplements for the 24 hours prior to the visit; not exercise for the 24 hours prior to the visit; not take any antihistamines for the 24 hours prior to the visit; and not drink any exercise recovery beverages over the entire time period of the 4 visits.

A typical test day can be as follows. Provide subject a standardized breakfast 30 to 60 minutes before starting the first exercise session and administer questionnaires about recent activity and food/beverage consumption. Immediately prior to starting the first session of exercise, collect a pre-Exhaustive Exercise blood sample for CPK, LDH, plasma nitrite and NOX metabolites. Measure the pre-Exhaustive Exercise blood pressure and heart rate, then subject performs the Exhaustive Exercise protocol. Upon completion of the exercise, collect the post-Exhaustive Exercise blood sample for CPK, LDH, plasma nitrite and NOX metabolites. Measure the post-Exhaustive Exercise blood pressure and heart rate and provide the first serving of study product (Cocoa Product or placebo or test) immediately after the blood collection. Administer the muscle condition and sensory questionnaire following beverage consumption. Measure the blood pressure and heart rate 1 hour after the first serving of study product. Two hours after completion of the first exercise session, collect the 2-hour blood sample for CPK, LDH, plasma nitrite and NOX metabolites. Measure the 2-hour blood pressure and heart rate. Provide the second serving of study product after the blood collection. Measure the blood pressure and heart rate 1 hour after the second serving of study product. Immediately prior to starting the second exercise session, collect the pre-TTE blood sample for CPK, LDH, plasma nitrite and NOX metabolites. Measure the pre-TTE blood pressure and heart rate and four hours after completion of the first Exhaustive Exercise session, have subject perform the TTE protocol. Upon completion of the exercise, collect the post-TTE blood sample for CPK, LDH, plasma nitrite and NOX metabolites. Measure the post-TTE blood pressure and heart rate. Measure the blood pressure and heart rate 30 minutes after completion of the second exercise session. Subjects will complete a questionnaire to evaluate their perceived muscle soreness at 24, 48, and 72 hours after the first exercise session (±120 minutes). The subject's follow-up visit should be approximately 72 hours post completion of the first exercise session (±120 minutes). Remind subject to avoid exercise during the time between the test and follow-up visits and avoid food or beverage other than water for the 8 hours prior to the visit.

The results of the blood samples surveys and the exercise performance are compared for the Cocoa Products and the test and placebo.

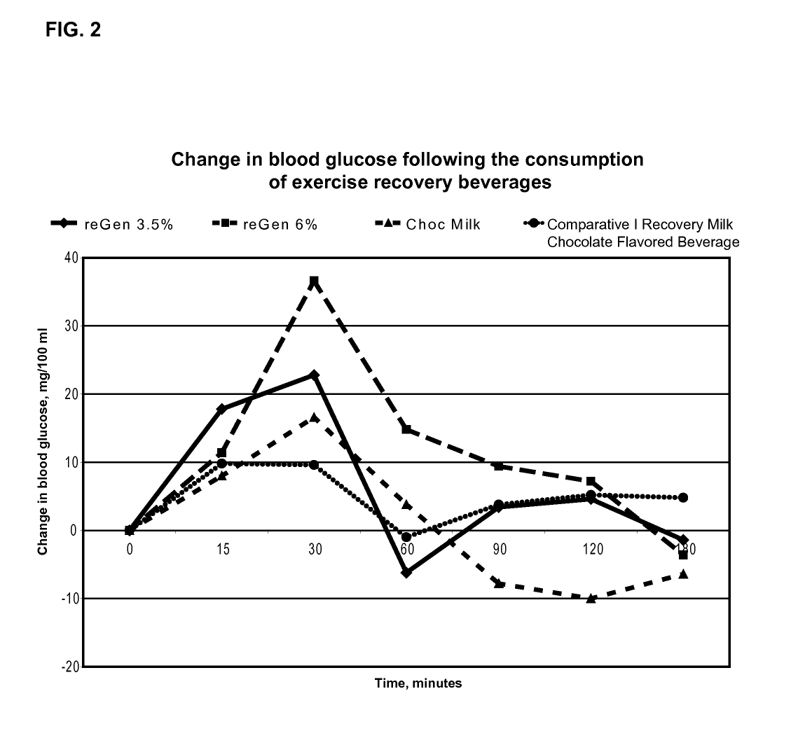

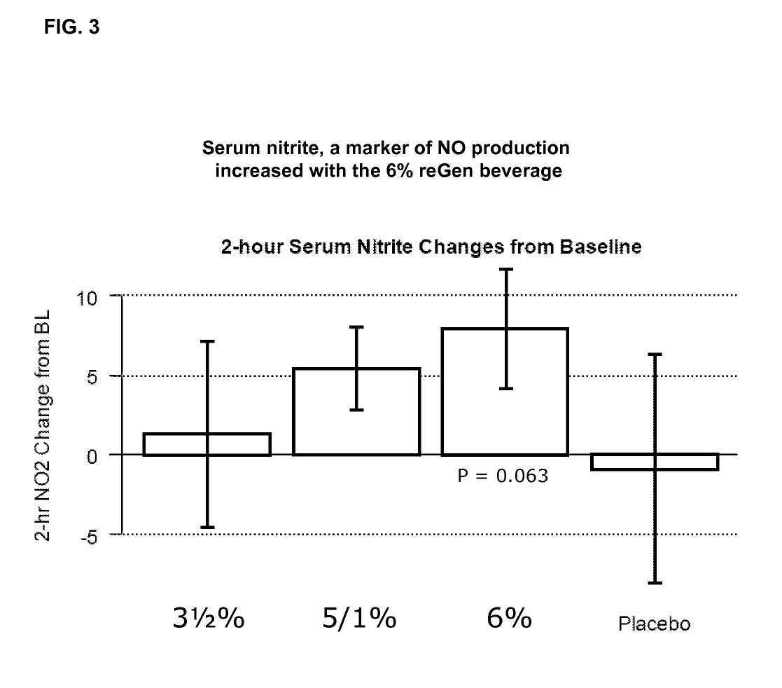

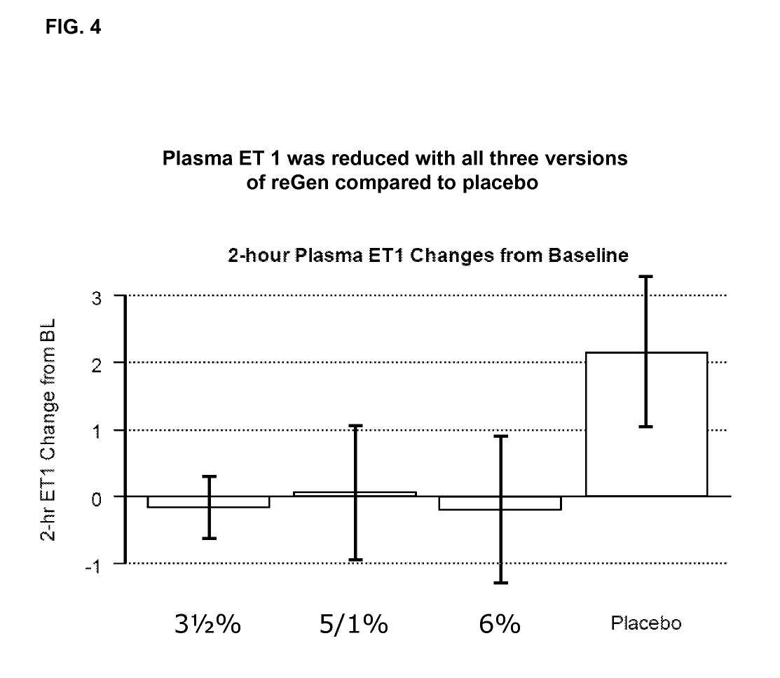

For example, five volunteers can be given a high cocoa beverage, have their blood sampled at 0, 15, 30, 60, 90, 120, and 180 minutes, and then be tested for glucose, nitrates, and endothelin-1. As shown in FIG. 2, the available glucose following administration of the high cocoa beverage or composition increases rapidly, indicating a high potential for restoring muscle carobohydrate stores. The protein present in the high cocoa beverage prevents catabolism that may degrade muscle tissue. Similarly, the levels of beneficial nitrite, a marker of nitric oxide (NO) are increased following administration (FIG. 3), and the levels of deleterious endothelin-1 are decreased (FIG. 4) relative to placebo controls. Accordingly, the compositions and beverages of the invention can be used to enhance exercise recovery, by athletes during training and recovery, and for improving energy supply to muscle tissue and amino acids for muscle regeneration.

Study Beverages

The following tables provide exemplary Cocoa Products of the invention as well as comparative test (Fluid Recovery) and placebo beverages.

Cocoa Product 1 (cocoa-based carbohydrate-and-protein beverage) containing the following ingredients: water; sugar; natural cocoa powder; milk protein isolate; and 2% or less of maltodextrin, salt, canola oil, dipotassium phosphate, cellulose gel, natural and artificial flavors, magnesium phosphate, carboxymethylcellulose, tricalcium phosphate, carrageenan, dextrose, Vitamin E acetate, Vitamin A palmitate, Vitamin D.

Nutrition Facts - Cocoa Product 1 (3.5% Natural Cocoa)

| Serving size 11 fl. Oz. (344.g) | |
|---|---|
| Servings Per Container 1 | |
| Amount Per Serving | |
| Calories 200 | |
| Calories from Fat 40 | |
| | % Daily Value* |
| Total Fat 4.5 g | 7% |
| Saturated Fat 1 g | 5% |
| Trans Fat 0 g | |
| Cholesterol 5 mg | 2% |
| Sodium 330 mg | 14% |
| Total Carbohydrates 35 g | 12% |
| Dietary Fiber 5 g | 20% |
| Sugars 25 g | |
| Protein 11 g | |
| Vitamin A | 10% |
| Vitamin C | 0% |
| Calcium | 20% |
| Iron | 6% |
| Vitamin D | 10% |
| Vitamin E | 10% |
| Potassium | 15% |
| Magnesium | 25% |

*Percent Daily Values are based on a 2,000 calorie diet.

Cocoa Product 2 (cocoa-based carbohydrate-and-protein beverage) containing the following ingredients: water; sugar; natural cocoa powder; milk protein isolate; and 2% or less of canola oil, dipotassium phosphate, salt, cellulose gel, natural and artificial flavors, magnesium phosphate, carboxymethylcellulose, tricalcium phosphate, carrageenan, dextrose, Vitamin E acetate, Vitamin A palmitate, Vitamin D.

Nutrition Facts - Cocoa Product 2 (6% Natural Cocoa)

| Serving size 11 fl. Oz. (347.g) | |
|---|---|
| Servings Per Container 1 | |
| Amount Per Serving | |
| Calories 220 | |
| Calories from Fat 50 | |
| | % Daily Value* |
| Total Fat 6 g | 9% |
| Saturated Fat 2 g | 10% |
| Trans Fat 0 g | |
| Cholesterol 5 mg | 2% |
| Sodium 330 mg | 14% |
| Total Carbohydrates 40 g | 13% |
| Dietary Fiber 8 g | 32% |
| Sugars 28 g | |
| Protein 13 g | |
| Vitamin A | 10% |
| Vitamin C | 0% |
| Calcium | 25% |
| Iron | 10% |
| Vitamin D | 10% |
| Vitamin E | 10% |
| Potassium | 15% |
| Magnesium | 40% |

*Percent Daily Values are based on a 2,000 calorie diet.

Product 3 Placebo containing the following ingredients: water; sugar; milk protein isolate; and 2% or less of canola oil, maltodextrin, dipotassium phosphate, salt, cellulose gel, natural and artificial flavors, magnesium phosphate, carboxymethylcellulose, tricalcium phosphate, carrageenan, dextrose, Vitamin E acetate, Vitamin A palmitate, Vitamin D.

Nutrition Facts - Placebo (No Natural Cocoa)

| Serving size 11 fl. Oz. (345.g) | |
|---|---|
| Servings Per Container 1 | |
| Amount Per Serving | |
| Calories 170 | |
| Calories from Fat 25 | |
| | % Daily Value* |
| Total Fat 3 g | 5% |
| Saturated Fat 0 g | 0% |
| Trans Fat 0 g | |
| Cholesterol 5 mg | 2% |
| Sodium 330 mg | 14% |
| Total Carbohydrates 27 g | 9% |
| Dietary Fiber 1 g | 4% |
| Sugars 24 g | |
| Protein 9 g | |
| Vitamin A | 10% |
| Vitamin C | 0% |
| Calcium | 20% |
| Iron | 10% |
| Vitamin D | 10% |
| Vitamin E | 10% |
| Potassium | 10% |
| Magnesium | 10% |

*Percent Daily Values are based on a 2,000 calorie diet.

Product 4 (Fluid Replacement—FR) containing: water, sucrose syrup, glucose-fructose syrup, citric acid, natural flavors, salt, sodium citrate, monopotassium phosphate, food color, ester gum, brominated vegetable oil, and no natural cocoa. Per 8 oz serving: 50 calories, 14 g sugar, 110 mg sodium, 30 mg potassium, 0 mg calcium, 0 mg magnesium, 0 mg phosphorus, 0 mg iron, 0 mg sulfate, 0 IU vitamin D3, 0 mg vitamin C, pH 3.5.

Composition and Production of Cocoa Beverages

Various amounts of natural cocoa powder can be selected for use in the beverages of the invention. The examples above referred to an 11 oz serving size for the Cocoa Product 1 and 2. Those products can contain approximately 20 grams per serving of cocoa powder. In Table 1 (below), additional examples show the number of grams of cocoa per 8 oz. serving when several different weight percent values of natural cocoa powder are used in the initial mixture.

TABLE 1

| Formula Option (% Natural Cocoa) | Cocoa |
|---|---|
| 3.0% | 7.7 gm/serving |
| 5.0% | 12.9 gm/serving |
| 7.0% | 18.0 gm/serving |
| 9.0% | 23.2 gm/serving |

Several test trials for a low fat milk-based product are shown in Table 2, labeled versions 1 to 4 (V-1 to V-4). The fat, protein, sugar content of these are shown below in Table 3.

TABLE 2

| Ingredient | V-1 | V-2 | V-3 | V-4 |
|---|---|---|---|---|
| Water | 0.00% | 0.00% | 0.00% | 0.00% |
| Milk Low Fat, 1% Fat | 87.00% | 84.00% | 81.00% | 78.00% |
| Sugar | 9.00% | 10.00% | 11.00% | 12.00% |
| Natural Cocoa Powder | 3.00% | 5.00% | 7.00% | 9.00% |
| Alkalized Cocoa Powder | 0.50% | 0.50% | 0.50% | 0.50% |
| Carageenan (Kappa) | 0.010% | 0.010% | 0.010% | 0.010% |
| Salt | 0.020% | 0.020% | 0.020% | 0.020% |
| Vanillin | 0.020% | 0.020% | 0.020% | 0.020% |
| Calcium Carbonate | 0.100% | 0.100% | 0.100% | 0.100% |
| Microcrystalline | 0.350% | 0.350% | 0.350% | 0.350% |
| Cellulose | | | | |
| Total | 100.00% | 100.00% | 100.00% | 100.00% |

TABLE 3

| Serving Size | | | | |
|---|---|---|---|---|
| (8 Fluid oz.) | V-1 | V-2 | V-3 | V-4 |
| Serving Size (grams) | 257.9 | 257.9 | 257.9 | 257.9 |
| KCAL/Serving | 223.9 | 251.5 | 279.2 | 306.9 |
| Protein/Serving | 9.5 | 10.3 | 11.1 | 11.9 |
| Protein % DV | 19% | 21% | 22% | 24% |
| Carbs/Serving | 39.0 | 43.8 | 48.6 | 53.3 |
| Fat/Serving | 3.2 | 3.7 | 4.2 | 4.7 |
| Calcium/Serving | 38% | 38% | 38% | 38% |
| Total Fat % | 1.26% | 1.45% | 1.64% | 1.83% |
| Milk Fat % | 0.87% | 0.84% | 0.81% | 0.78% |
| Milk Solids Non Fat % | 7.57% | 7.31% | 7.05% | 6.79% |
| Total Solids % | 21.4% | 24.1% | 26.8% | 29.6% |
| Sugar Alcohols | — | — | — | — |

A soy-based product can be similarly produced using the ingredients shown in Table 4. Again, an expected density of about 1.09 gm/cc product can be produced.

TABLE 4

| Ingredients | Soy-1 |
|---|---|
| Water | 81.736% |
| Milk, Whole, 3.25% Fat | |
| Milk Reduced Fat, 2% Fat | |
| Milk Low Fat, 1% Fat | |
| Non-Fat Dry Milk | |
| Skim Milk | |
| Dairy Protein | |
| Erythritol | |
| Liquid Sugar | |
| Sugar | 10.000% |
| Sucralose - Dry | |
| Ace-K - Dry | |
| Natural Cocoa | 2.400% |
| Alkalized Cocoa | 0.400% |
| Micro Cellulose | 0.300% |
| Sweet Flavor | |
| DiSodium Phosphate | |
| Salt | 0.150% |
| Vanillin | 0.023% |
| Vanilla Flavor | 0.100% |
| Calcium Carbonate | |
| Vitamin A/D Blend | |
| Soybean Oil | 0.900% |
| Masking Flavor | 0.200% |
| Soy protein Concentrates | 3.450% |
| Vitamin Mix | 0.341% |
| Total | 100.00% |

The soy-based products can be made to have the following contents using the same ingredients as above as shown in Table 4. The ingredients listed in Table 4 can be used in any embodiment of the invention. In addition, other flavoring agents, such bitter-masking flavor agents, acid-masking flavor agents, mouthfeel flavor agents, and other flavors known, used or available for the beverage industry can be selected and used in any embodiment of the invention. Table 5 shows exemplary nutritional information for soy-based beverages. In general, the range of cocoa powder in the soy-based beverages is slightly lower than in the milk-based beverages, but there is no requirement that it be lower than the levels described above.

TABLE 5

| Serving Size | | | | |
|---|---|---|---|---|
| (8 Fluid oz.) | | | | |
| Serving Size (grams) | 257.9 | 257.9 | 257.9 | 257.9 |
| KCAL/Serving | 178.2 | 157.5 | 178.2 | 157.5 |
| Protein/Serving | 8.3 | 8.3 | 8.3 | 8.3 |
| Protein % DV | 17% | 17% | 17% | 17% |
| Carbs/Serving | 29.5 | 24.3 | 29.5 | 24.3 |
| Fat/Serving | 3.6 | 3.6 | 3.6 | 3.6 |
| Calcium/Serving | 1.1% | 1.1% | 1.1% | 1.1% |
| Total Fat % | 1.38% | 1.38% | 1.38% | 1.38% |
| Milk Fat % | 0.00% | 0.00% | 0.00% | 0.00% |
| MSNF % | 0.00% | 0.00% | 0.00% | 0.00% |
| Total Solids % | 17.8% | 15.8% | 17.8% | 15.8% |
| Sugar Alcohols | — | — | — | — |

Additional processing steps can be incorporated into a production process, including removing substances or particulates by filtration, such as membrane filtration, ultrafiltration, and microfiltration. In general, the milk-based products are buffered at about pH 6.5 to about 6.8, or about pH 6.5 to about 7.0, and various buffering and complexing agents can be used, including ascorbic acid, sodium bicarbonate, disodium phosphate, citric acid, sodium ascorbate, or other food acids and buffers. However, milk or milk isolates can also provide a pH buffering effect.

In general, a pressurized process is preferred for certain heating steps, for example to reduce flashing during ultra high temperature treatment, however, certain steps may not require or employ pressure. A variety of pressure ranges are known to and can be used by one of skill in the art in any of the embodiments of the invention.

In addition, centrifugation steps or methods may be used.

The following Tables relate to several tests of finished final product in containers, according to the invention, and the stability of the products, and the stability of the beverage suspension attributes in particular, after storage and other conditions. In Table 6 below, samples 3-6 contain cocoa levels below 2.5% total cocoa powder and are consistent with conventional chocolate milk products. For each of the other samples in Tables 6-9, the products contain about 3% natural cocoa powder by weight and about 0.5% alkalized cocoa powder by weight, or the equivalent in a cocoa solids levels for a cocoa product or cocoa bean-derived product, and certain soy samples listed may contain levels of about 2.4% natural cocoa powder and 0.4% alkalized cocoa powder. Additional ingredients, such as vanilla or vanillin, or coffee for mocha examples, are listed in the names of the samples in the Tables.

TABLE 6

| | | Unshaken | | |
|---|---|---|---|---|
| | Sample | Gel | Separation | Bottom |
| 1 | Extra Dark | 0 | 0 | 0 |
| 2 | Extra Dark - No Sugar Added | 0 | 0 | 0 |
| 3 | Choc Milk | 1 | 0 | 0 |
| 4 | Choc Milk - No Sugar Added | 1 | 0 | 0 |
| 5 | Choc Soy Milk | 0 | 1 | 0 |
| 6 | Mocha Soy Milk | 2 | 0 | 0 |

The samples in Table 6 are an 3.5% total cocoa powder by weight (“Extra Dark” or as EDCS in Tables 7-9) produced with other ingredients as listed. For each of Tables 6-9, the ratings and numbers reported correspond to the following:

### Gel

0 No gel formation noticed

1 Slight gel seen when twisting container

2 Slight gel seen when pouring from container

3 Obvious gelation

4 Clumping

5 Complete system failure with visible clumping

### Separation

0 No serum separation noticed

1 Slight meniscus on surface

2 Slight meniscus on surface with striation or swirls on side

3 Visible serum which can be poured from surface

4 Surface serum greater than 1 cm

5 Complete system failure with two or more separate and distinct phases

### Bottom of Container

0 No cocoa or insolubles on floor

1 Slight dusting on floor

2 Moderate cocoa dusting

3 Heavy dusting, can be shaken back in product with minimal effort

4 Heavy dusting that forms pellet. Does not resuspend with minimal effort

5 Complete system failure with all cocoa and other insolubles on floor. Fluid material clear or white.

Additional groups of samples were similarly tested and the results are presented in the Tables below.

TABLE 7

| Sample | Gel | Separation | Dusting | Notes |
|---|---|---|---|---|
| Dark Choc Soy | 2 | 0 | 1 | OK |
| Extra Dark | 0 | 0 | 0 | Very good |
| Extra Dark - No Sugar | 0 | 0 | 0 | Very good |
| Added (NSA) | | | | |

TABLE 8

| Sample | Gel | Separation | Dusting | Notes |
|---|---|---|---|---|
| EDCS NSA | 0 | 1 | 0 | Good |
| Dark Soy | 2 | 1 | 1 | Fair |
| EDCS NSA | 0 | 0 | 1 | Slight dusting of cocoa |
| | | | | on floor |
| EDCS | 0 | 0 | 1 | Slight dusting |
| EDCS NSA | 0 | 0 | 1 | Slight dusting |

TABLE 9

| Product | Gel | Separation | Dusting | Notes |
|---|---|---|---|---|
| EDCS | 0 | 0 | 1 | Very good |
| EDCS NSA | 0 | 0 | 1 | Very good |
| Soy Milk - Dark | 3 | 2 | 2 | Gel is strong |
| EDCS NSA | 0 | 0 | 0 | Beautiful |

Some of the samples above have been stability tested up to twelve months from date of original bottling or placing into containers. These products remain in a stable solution, do not show signs of contamination, and retain the beneficial taste, beverage suspension, mouthfeel, and other properties discussed above. In the Tables above, “EDCS” refers to an extra dark chocolate shake-type product or beverage of the invention, and “NSA” refers to no sugar added embodiments. Thus, the ready-to-drink, shelf stable or extended shelf life beverages produced from the methods and examples described above contain a high level of cocoa solids, and thus a high level of cocoa flavanol antioxidants. In comparison, prior chocolate milk beverages with very high levels of cocoa contain perhaps up to 12% of a chocolate flavor, typically a chocolate syrup, where chocolate syrup is only about 8% cocoa powder, and where chocolate syrup is typically made from high levels or essentially all alkalized or dutched cocoa products. These could result in perhaps 1.5% cocoa powder equivalent but only if made with the highest levels of chocolate flavor. Typical chocolate milk formulations have only about 1% cocoa powder and less than about 200 mg total polyphenol per 8 oz serving. Furthermore, these products would contain much lower levels of cocoa antioxidants due to the use of dutched cocoa. The beverages of the invention contain higher levels of cocoa powder, or cocoa solids, use a high percentage of natural cocoa powder that is rich in cocoa flavanol antioxidants, and the beverages are stable to room temperature shelf storage. Prior chocolate milk and soymilk beverages fall short in one or more of these categories. Accordingly, the ready-to-drink beverages of the invention are produced from an improved method that results in a better tasting, improved mouthfeel, and much more stable product with high level of beneficial cocoa antioxidants.

Table 10 below reports the measurements of beneficial cocoa antioxidants present in exemplary beverages of the invention, where TP refers to total polyphenols, ORAC is measured at micromoles of Trolox Equivalent per gram, and the serving size is 8 oz.

TABLE 10

| | Density | | ORAC | | ORAC/ |
|---|---|---|---|---|---|
| Sample | (gm/cc) | TPmg/gm | umTE/gm | TP/serving | svg |
| Extra Dark | 1.0777 | 2.18 | 33 | 556 | 8,414 |
| Extra Dark - NSA | 1.0409 | 1.98 | 27 | 488 | 6,649 |
| Extra Dark | 1.07 | 1.70 | 33 | 430 | 8,354 |
| Extra Dark Soy | 1.0617 | 4.15 | 32 | 1,042 | 8,038 |
| Extra Dark - NSA | 1.0405 | 2.79 | 24 | 687 | 5,908 |

For the final product formulation process or manufacturing process of a beverage of the invention, various properties can be controlled for or adjusted, for example, the pH, the concentration of the cocoa component of the beverage and the concentration of the cocoa polyphenols and/or cocoa flavanols, the taste, the sweetness, and the mouthfeel. Color variations can be produced by using dutched cocoa powder and adding coloring agents. In addition, sweeteners, such as sugar, sugar alcohols, saccharides, dextrins, can be used, as well as carrageenans, flavors, emulsifiers, gum arabic, weighting agents, stabilizers or other seasoning agents or flavoring agents can be added, preferably at the initial mixing step, but optionally later. Stabilizers, in general, can be any beverage stabilizer, but preferred are cellulose products and especially preferred are microcrystalline cellulose products.

As mentioned above, various dietary additives, supplements, minerals, and vitamins, and herbal and ingestible extracts can be added to the compositions of the invention, or used in the methods. In particular, a bitter blocker agent or agents, one or more mouth-watering agents, and/or one or more sweetness enhancers can be used. In one such example, an adenosine monophosphate compound can be selected, but any bitter blocker agent or compound known or available can be selected.

The nutritive or carbohydrate sweetener used in the beverages can be any known in the art, including, alone or in any combination, sucrose, fructose, maltose, dextrose, liquid fructose, lactose, glucose, trehalose, oligofructose, inulin, agave syrup, corn syrup, invert sugar, honey, cane syrup, maple sugar, brown sugar, and molasses, for example.

Additional food ingredients or edible ingredients can be combined with any of the compositions and combinations of the invention. Especially preferred are one or more of the GRAS (generally recognized as safe) flavoring agents available or known. Organic sweeteners, such as sugars of organic cane juice, can also be used. The carbohydrate sweeteners used for the carbohydrate content of the exercise recovery beverage examples of the invention can include, but are not limited to, one or more of sucrose (sugar), maltodextrin, dextrose, glucose, and corn syrup solids, and combinations of these As noted above, sweetening agents and derivatives thereof can be used, including but not limited to aspartame, acesulfame potassium (Ace-K), saccharine, cyclamate, glycyrrhizine, sucralose, cyclamates, dihydrochalcones, stevisoide and rebaudioside A or stevia extract sweeteners, thaumatin, monellin, neohesperidine, and any of the polyol compounds. A preferred polyol or sugar alcohol is erythritol, but any others can be selected, alone or in any of various combinations possible, from, for example, xylitol, mannitol, sorbitol, and maltitol. Sugar substitutes, as known and available in the art, can also be used, alone or in various combinations. In addition, a sweetener or sweetener composition used in any embodiment of the invention can be, for example, sucralose and neotame, alone or in combination. The non-nutritive, high-intensity sugar substitutes in general can also be used, including aspartame, Ace-K, cyclamate, and alitame. Other sugars than can be used in any embodiment of the invention include sucrose, fructose, liquid fructose compositions, especially liquid fructose at about 90% in water, and corn syrups, and combination of these. Sweetness enhancers can also be used, such as vanillin and other compounds available in the art.

Additional functional ingredients or additives can be added, as know in the art, including, alone or in any one or more combinations: Vitamin B-Complex; Ginseng; Ginkgo Biloba; Caffeine; Theobromine; Hoodia Gordonii; Gymnema Sylvestre; Hydroxycitrate: Green Tea Leaf Extract; Betaine; Piperine; Potassium; Maltodextrin; Vitamin C; Vitamin E; Thiamin; Riboflavin; Niacinamide; Pyridoxine Hydrochloride; Biotin; Chromium; Molybdenum; Garcinia Cambogia; Congugated Linoleic Acid (CLA); Glucosol; Guarana; Hawthorn; ECGC (epigallocatechin-3-gallate); Vitamins A, D, D3, B1, B2, B3, B6, B12; Folic Acid; Pantothenic Acid; Biotin; Calcium; Iodine; Magnesium; Zinc; Selenium; Manganese; Chromium; Creatine Monohydrate; Molybdenum; Potassium; Inositol; Alpha Lipoic Acid; Co-Enzyme Q10; Grape Seed extract; Hawthorne extract; Acai berry extract; L-Leucine; L-Taurine; L-Arginine; Muira Puama; Avena Sativa; Tribulis Terristris; Choline; Androstenedione; L-Glutamine; L-Tyrosine; L-Arginine; L-Glycine; L-Lysine; Whey Protein; DHEA (Dehydroepiandrosterone); Grape Seed extract; Alpha Lipoic Acid; Green Tea extract; and plant sterols, such as phytosterols, phytosterol esters, phytostanols, phytostanol esters, and more particularly various positional isomers, stereoisomers, hydrogenated forms and/or phytostanol esters of the following non-limiting list of general plant sterols: sitosterol, campesterol, stigmasterol, spinosterol, taraxasterol, brassicasterol, desmosterol, chalinosterol, poriferasterol, clionasterol, avenosterol, and ergosterol.

As noted herein, some of the exercise recovery beverages or compositions are reduced calorie products (Light), and thus sugar substitutes and sweeteners are preferred, especially in producing products with a per serving calorie count of less than or about 100 calories, or less than or about 140 calories per serving (11 oz serving size). Other beverages or compositions of the invention can be even lower in the total calorie content.

In addition, any of the beverages or compositions of the invention can preferably be produced as a lactose-free product, or substantially lactose free. A product is substantially lactose free when none of the ingredients used contain lactose as one of the labeled or identified ingredients. However, products or ingredients with trace amounts of lactose, such as various milk products that have been treated to remove lactose, are specifically included in a lactose free ingredient that can be used. Lactose-free compositions can be 99.9% lactose free or may have less than about 0.5 grams lactose per serving or 0.03% lactose.

The examples presented above and the entire content of the application define and describe examples of the many cocoa beverages, compositions, products, and methods that can be produced or used according to the invention. None of the examples and no part of the description should be taken as a specific limitation on the scope of the invention as a whole or of the meaning of the following claims.

What is claimed is:

1. A method of producing an exercise recovery beverage comprising:
mixing an aqueous composition of one or more of milk, milk protein or dairy protein with a carbohydrate sweetener, a beverage stabilizing agent, and a cocoa product, wherein the beverage contains a cocoa product present in an amount equivalent to the cocoa solids content present in about 3.5% to about 10% by weight cocoa powder, and wherein about 80% or more of the cocoa powder or cocoa product used is not treated with alkalizing conditions, and the carbohydrate sweetener is present at a ratio between 2.5:1 to 4:1 to the protein present;
treating the mixture to ultra high temperature conditions of about 275° to about 290° F. for about 1 second to about 10 seconds;
homogenizing the mixture;
and filling the beverage into a container.

2. The method of claim 1, wherein the cocoa product is natural cocoa powder and wherein an 11 oz. serving of the beverage contains about 150 mg or more of total cocoa flavanols.

3. The method of claim 2, wherein the cocoa product is present at about or the equivalent of 5% to about 6% cocoa powder by weight in the final beverage.

4. The method of claim 1, wherein the beverage stabilizing agent is a microcrystalline cellulose.

5. The method of claim 1, wherein the mixture of the aqueous composition and cocoa product is buffered at about pH 6.5 to about pH 7.0.

6. The method of claim 1, wherein a milk is used as the aqueous composition, and the milk is selected from one of whole milk, low fat milk, fractionated milk, lactose-free milk, or non fat milk.

7. The method of claim 1, wherein the carbohydrate sweetener comprises one or more of sugar, maltodextrin, and dextrose.

8. The method of claim 1, wherein sugar is used in combination with a non-nutritive sweetener.

9. The method of claim 1, further comprising adding a carrageenan.

10. The method of claim 1, further comprising adding one or more of carboxymethylcellulose or a cellulose gel.

11. The method of claim 1, further comprising adding one or more of an appetite suppressant, theobromine, caffeine, a vitamin, or a mineral.

12. The method of claim 1, wherein the cocoa product comprises a cocoa powder from unroasted cocoa beans.

13. The method of claim 1, wherein the cocoa product comprises a cocoa powder or product from unfermented or raw cocoa beans.

14. The method of claim 1, wherein the cocoa product comprises a defatted cocoa powder.

15. The method of claim 1, wherein cocoa fiber present from the cocoa product is in the range of about 4 to about 20 grams per serving.

16. The method of claim 15, wherein no additional high fiber ingredients are used.

17. A method of producing a stable beverage composition, the beverage composition comprising an aqueous composition of a carbohydrate sweetener and dairy protein at about a ratio of 2.5:1 to 4:1, about 3.5% to about 10% total cocoa powder by weight or the equivalent in cocoa solids, and a beverage stabilizer;
the method comprising adjusting the pH to about pH 6.5 to about pH 7;
heating the composition to about 275° to about 290° F. for about 1 second to about 10 seconds;
and thereafter homogenizing the composition.

18. A beverage made from the method of claim 17.

19. A beverage made from the method of claim 17, wherein whole milk is used.
